(19) United States
(12) Patent Application Publication
(10) Pub. No.: US 2026/0012934 A1
(43) Pub. Date: Jan. 8, 2026

(54) METHODS, APPARATUSES, AND DEVICES FOR CONFIGURING REFERENCE SIGNAL PATTERNS

(71) Applicant: Huawei Technologies Co., Ltd., Shenzhen (CN)

(72) Inventors: Xiaoyan Bi, Shanghai (CN); Jianglei Ma, Ottawa (CA)

(21) Appl. No.: 19/305,438

(22) Filed: Aug. 20, 2025

Related U.S. Application Data
(63) Continuation of application No. PCT/CN2023/079141, filed on Mar. 1, 2023.

(51) Int. Cl. H04W 72/0453; H04L 5/00

(52) U.S. Cl. CPC H04W 72/0453; H04L 5/0048

(57) ABSTRACT

Aspects of the present disclosure provide methods, apparatuses, and devices for configuring reference signal (RS) patterns, for example sparse RS patterns, used for the RS occurring in a resource zone to reduce RS-related signaling overhead, such as RS configuration or RS indication overhead. A base station (BS) may transmit, to a user equipment (UE) configuration information to be used in conjunction with at least one RS pattern to determine when transmission of an RS occurs in a resource zone, whereby the resource zone comprises at least one subband and each subband comprises at least one resource block. The UE may determine when the RS is to be transmitted by the UE or received by the UE, based on the at least one RS pattern and the configuration information.

### CROSS REFERENCE

The present disclosure is a continuation of International Application No. PCT/CN2023/079141, filed on Mar. 1, 2023, the disclosure of which is hereby incorporated by reference in its entirety.

### TECHNICAL FIELD

The present disclosure relates generally to wireless communications, and in particular to methods, apparatuses, and devices for configuring reference signal patterns in a wireless network.

### BACKGROUND

Existing wireless communication systems (e.g., Fourth Generation (4G) long-term evolution (LTE), Fifth Generation (5G) New Radio (NR)) may support a multiple-input multiple-output (MIMO) technology to transmit multiple data signals simultaneously over the same radio channel.

To support MIMO data transmission (e.g., support transmit MIMO (T-MIMO)) with ultra-high dimensional transmit and receive antenna ports and ultra wide bandwidth, for example at 10 GHz, sparse reference signal (RS) patterns have been proposed for data transmission and channel state information (CSI) acquisition. Sparse RS patterns have been useful to achieve a certain level of performance. A sparse RS pattern is a pattern that spreads RSs in at least one of time, frequency, or space. The greater the sparseness, or sparsity, in frequency of the RSs, the larger the bandwidth needed for transmission of the RS. Sparsity of the RS pattern may also be related to channel statistical characteristics, which may be slow-varying over time and slightly faster-varying for mapping between frequency and antenna port.

Sparse RS patterns may be uniform or non-uniform in time, frequency, and/or spatial domains. As such, configuring sparse RS patterns may be a key factor for obtaining good performance. However, existing methods for configuring sparse RS patterns are not optimized. For example, substantial signaling overhead may occur when configuring sparse RS patterns. Therefore, new methods for configuring RS patterns are needed to reduce signaling overhead.

### SUMMARY

Aspects of the present disclosure provide methods, apparatuses and devices to overcome the shortcomings and limitations described above, as well as specific methods, apparatuses and devices for configuring RS patterns to reduce RS-related signaling overhead, such as RS configuration or RS indication overhead.

According to an aspect of the disclosure there is provided a method including receiving, by a user equipment (UE) from a base station (BS), configuration information to be used in conjunction with at least one reference signal (RS) pattern to determine when transmission of an RS signal occurs in a resource zone comprising at least one subband and each subband comprises at least one resource block; based on the at least one RS pattern and the configuration information, determining, by the UE, when the RS is to be transmitted by the UE or received by the UE.

In some embodiments, the method further includes receiving, by the UE from the BS, at least one RS pattern, each of the at least one RS pattern indicating particular resource elements of a resource block used for the RS, wherein the resource block comprises a plurality of resource elements.

In some embodiments, the configuration information includes at least one of: a number of resource block (RB) groups in a subband of the at least one subband; a number of RBs in each RB group; a starting RB indicating a first end of a subband of the at least one subband; an ending RB indicating a second end of a subband of the at least one subband; a transmission bandwidth for the RS; a reference point for a start of the RS; or an indication to partition a wide band into a plurality of subbands.

In some embodiments, the configuration information comprises RS pattern modification information or RS pattern mapping information comprising at least one of: pattern shift information indicating a shift of location of resource elements used for the RS in the at least one RS pattern; RS pattern density change information indicating a change in a number of REs used for the RS within the at least one RS pattern; RS resource block information indicating resource blocks that include at least one RS; antenna port mapping information indicating a mapping of a RS in the at least one RS pattern and one or more antenna ports; and enabling/disabling RS information indicating particular resource elements of the at least one RS pattern are enabled or disabled for transmission of the RS in the at least one RS pattern.

In some embodiments, the RS resource block information comprises a bitmap, wherein resource blocks that include at least one RS are indicated in the bitmap by a first bit and resource blocks that do not include any RS are indicated by a second bit.

In some embodiments, the RS pattern density change information comprises a pattern density change to indicate a change in density of the RS in comparison to the at least one RS pattern.

In some embodiments, the pattern shift information comprises a pattern shift index corresponding to a shift of the RS from a first resource element indicated in the at least one RS pattern to a second resource element.

In some embodiments, the pattern shift information is at least one of: specific to a particular multiple-input-multiple-output (MIMO) layer; or specific to the BS.

In some embodiments, the pattern shift information further comprises pattern shift index configuration information comprising an association between an amount of shift and the patter shift index; and wherein the pattern shift index configuration information is received via radio resource control (RRC) signaling and the pattern shift index is received via downlink control information (DCI) signaling.

In some embodiments, the RS pattern density change information is specific to a particular antenna port.

In some embodiments, the RS pattern density change information is associated with at least one of: a resource zone size; or a number of subbands in the resource zone.

In some embodiments, the at least one RS pattern is received via RRC signaling.

In some embodiments, the antenna port mapping information is received via media access control-control element (MAC-CE) signaling or DCI signaling.

In some embodiments, multiple RS patterns of the at least one RS pattern are combined in one subband.

In some embodiments, the multiple RS patterns are: the same RS pattern repeated more than once; or at least two different RS patterns with at least one RS pattern repeated more than once.

According to an aspect of the disclosure there is provided a user equipment (UE) for configuring RS patterns including a processor and a computer-readable medium. The computer-readable medium has stored thereon computer executable instructions that when executed cause the processor to perform a method consistent with the embodiment described above.

According to an aspect of the disclosure, there is provided a non-transitory computer readable storage medium, wherein the computer readable storage medium stores instructions that, when executed by a processor of an apparatus, enable the apparatus to perform a method as described above.

According to an aspect of the disclosure there is provided a method including transmitting, by a BS to a UE, configuration information to be used in conjunction with at least one RS pattern to determine when transmission of an RS signal occurs in a resource zone comprising at least one subband and each subband comprises at least one resource block; wherein the RS is determined to be transmitted or received based on the at least one reference signal (RS) pattern and the configuration information.

In some embodiments, the method further includes: transmitting, by the BS to the UE, at least one RS pattern, each of the at least one RS pattern indicating particular resource elements of a resource block used for the RS, wherein the resource block comprises a plurality of resource elements.

In some embodiments, the configuration information comprises at least one of: a number of RB groups in a subband of the at least one subband; a number of RBs in each RB group; a starting RB indicating a first end of a subband of the at least one subband; an ending RB indicating a second end of a subband of the at least one subband; a transmission bandwidth for the RS; a reference point for a start of the RS; or an indication to partition a wide band into a plurality of subbands.

In some embodiments, the configuration information comprises RS pattern modification information or RS pattern mapping information comprising at least one of: pattern shift information indicating a shift of location of resource elements used for the RS in the at least one RS pattern; RS pattern density change information indicating a change in a number of REs used for the RS within the at least one RS pattern; RS resource block information indicating resource blocks that include at least one RS; antenna port mapping information indicating a mapping of a RS in the at least one RS pattern and one or more antenna ports; and enabling/disabling RS information indicating particular resource elements of the at least one RS pattern are enabled or disabled for transmission of the RS in the at least one RS pattern.

In some embodiments, the RS resource block information comprises a bitmap, wherein resource blocks that include at least one RS are indicated in the bitmap by a first bit and resource blocks that do not include any RS are indicated by a second bit.

In some embodiments, the RS pattern density change information comprises a pattern density change to indicate a change in density of the RS in comparison to the at least one RS pattern.

In some embodiments, the pattern shift information comprises a pattern shift index corresponding to a shift of the RS from a first resource element indicated in the at least one RS pattern to a second resource element.

In some embodiments, the pattern shift information is at least one of: specific to a particular MIMO layer; or specific to the BS.

In some embodiments, the pattern shift information further comprises pattern shift index configuration information comprising an association between an amount of shift and the pattern shift index; and wherein the pattern shift index configuration information is transmitted via RRC signaling and the pattern shift index is transmitted via DCI signaling.

In some embodiments, the RS pattern density change information is specific to a particular antenna port.

In some embodiments, the RS pattern density change information is associated with at least one of: a resource zone size; or a number of subbands in the resource zone.

In some embodiments, the at least one RS pattern is transmitted via radio resource control (RRC) signaling.

In some embodiments, the antenna port mapping information is transmitted via MAC-CE signaling or DCI signaling.

In some embodiments, multiple RS patterns of the at least one RS pattern are combined in one subband.

In some embodiments, the multiple RS patterns are: the same RS pattern repeated more than once; or at least two different RS patterns with at least one RS pattern repeated more than once.

According to an aspect of the disclosure there is provided a base station (BS) for configuring RS patterns including a processor and a computer-readable medium. The computer-readable medium has stored thereon computer executable instructions that when executed cause the processor to perform a method consistent with the embodiment described above.

According to an aspect of the disclosure, there is provided a non-transitory computer readable storage medium, wherein the computer readable storage medium stores instructions that, when executed by a processor of an apparatus, enable the apparatus to perform a method as described above.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1A is a schematic diagram of a communication system in which embodiments of the present disclosure may occur.

FIG. 1B is another schematic diagram of a communication system in which embodiments of the present disclosure may occur.

FIG. 2 is a block diagram illustrating units or modules in a device in which embodiments of the present disclosure may occur.

FIG. 3 is a block diagram illustrating units or modules in a device in which embodiments of the present disclosure may occur.

FIG. 4 illustrates an example of a portion of the time and frequency resource having two resource zones in which sparse RS patterns may be used, in accordance with embodiments of the present disclosure.

FIG. 5 illustrates an example of a bitmap, where each bit of the bitmap corresponds to a particular resource block comprising 12 resource elements, and where a crosshatched bit indicates that the resource block includes an RS pattern, in accordance with embodiments of the present disclosure.

FIG. 6 illustrates an example of particular resource elements of a plurality of resource elements, some of which include RS forming an RS pattern, and two additional examples of a corresponding number of resource elements that indicate a shift of the location of the resource elements forming the RS pattern with the same period, in accordance with embodiments of the present disclosure.

FIG. 7 illustrates an example of particular resource elements of a plurality of resource elements, some of which include RS forming an RS pattern, and two additional examples of a corresponding number of resource elements with a change in the number of resource elements that include the RS, thereby changing the period of the RS pattern, in accordance with embodiments of the present disclosure.

FIG. 8 illustrates an example of mapping of a reference RS pattern for a time and frequency resource and two examples of how the pattern may be applied to map RS resources to one or more antenna ports, in accordance with embodiments of the present disclosure.

FIG. 9 illustrates an example of an RS pattern that is used to configure an RS on multiple antenna ports and how the RS pattern may be used to indicate particular resource elements in the pattern are either enabled and disabled for transmission of the RS in an RS pattern, in accordance with embodiments of the present disclosure.

FIG. 10 illustrates an example of indicating particular resource elements of a time and frequency resource block, across multiple antenna ports, that are used for at least one RS using multiple basic RS patterns, in accordance with embodiments of the present disclosure.

FIG. 11 is a signal flow diagram for signaling between a user equipment (UE) and a base station (BS) illustrating an example process for configuring RS patterns used for at least one RS occurring in a resource zone, in accordance with embodiments of the present disclosure.

### DETAILED DESCRIPTION

For illustrative purposes, specific example embodiments will now be explained in greater detail below in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e. DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

Aspects of the present disclosure may provide methods, apparatuses and devices for configuring RS patterns to reduce RS-related signaling overhead, such as RS configuration or RS indication overhead. According to some embodiments, configuration information may be used in conjunction with at least one RS pattern to support a sparse RS pattern for multiple-input multiple-output (MIMO) data transmission or Tera-bitsMIMO (T-MIMO). The configuration information for the RS pattern may have low RS-related signaling overhead, such as low RS configuration overhead or low RS indication overhead. The configuration information may be flexible in respect of generating arbitrary RS patterns and mapping resource elements used for the RS to one or more resource zones, for example in time, frequency, and/or spatial domains. In some embodiments, the configuration information may be applicable to ultra wide bandwidth (UWB) cases. Detailed illustration of the configuration information to be used in conjunction with at least one RS pattern, for example sparse RS patterns, to determine when transmission of an RS signal occurs in a resource zone is provided below and elsewhere in the present disclosure.

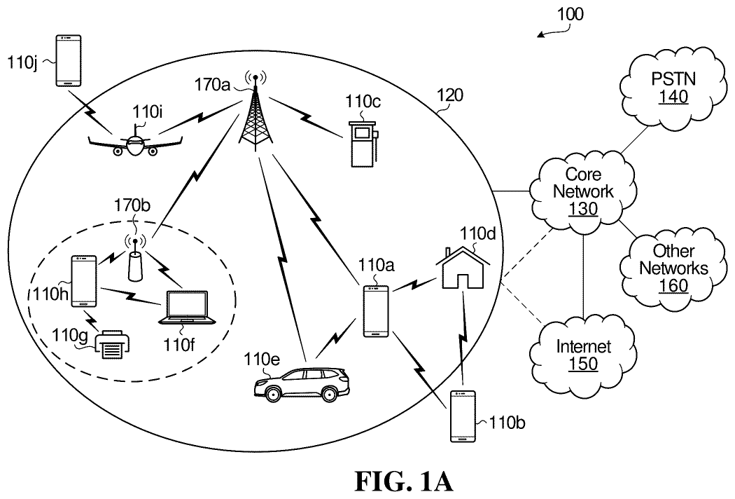

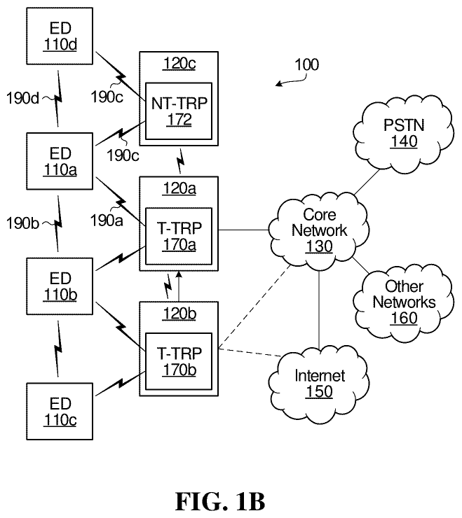

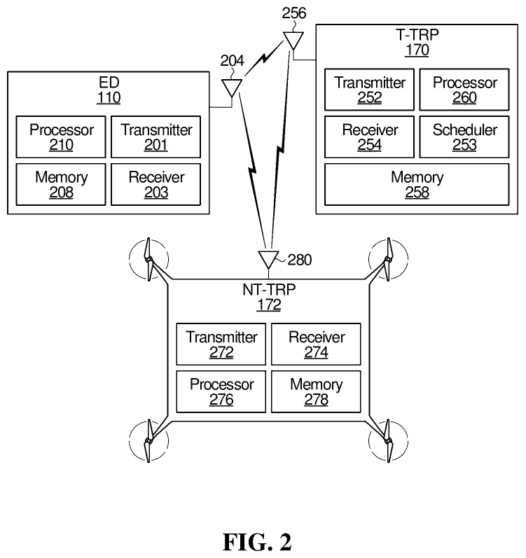

FIGS. 1A, 1B, and 2 following below provide context for the network and device that may be in the network and that may implement aspects of the present disclosure.

Referring to FIG. 1A, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another, and may also or instead be connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

FIG. 1B illustrates an example communication system 100 in which embodiments of the present disclosure could be implemented. In general, the system 100 enables multiple wireless or wired elements to communicate data and other content. The purpose of the system 100 may be to provide content (voice, data, video, text) via broadcast, narrowcast, user device to user device, etc. The system 100 may operate efficiently by sharing resources such as bandwidth.

In this example, the communication system 100 includes electronic devices (ED) 110a-110c, radio access networks (RANs) 120a-120b, a core network 130, a public switched telephone network (PSTN) 140, the Internet 150, and other networks 160. While certain numbers of these components or elements are shown in FIG. 1B, any reasonable number of these components or elements may be included in the system 100.

The EDs 110a-110c are configured to operate, communicate, or both, in the system 100. For example, the EDs 110a-110c are configured to transmit, receive, or both via wireless communication channels. Each ED 110a-110c represents any suitable end user device for wireless operation and may include such devices (or may be referred to) as a user equipment/device (UE), wireless transmit/receive unit (WTRU), mobile station, mobile subscriber unit, cellular telephone, station (STA), machine type communication device (MTC), personal digital assistant (PDA), smartphone, laptop, computer, touchpad, wireless sensor, or consumer electronics device.

FIG. 1B illustrates an example communication system 100 in which embodiments of the present disclosure could be implemented. In general, the communication system 100 enables multiple wireless or wired elements to communicate data and other content. The purpose of the communication system 100 may be to provide content (voice, data, video, text) via broadcast, multicast, unicast, user device to user device, etc. The communication system 100 may operate by sharing resources such as bandwidth.

In this example, the communication system 100 includes electronic devices (ED) 110a-110d, radio access networks (RANs) 120a-120c, a core network 130, a public switched telephone network (PSTN) 140, the internet 150, and other networks 160. Although certain numbers of these components or elements are shown in FIG. 1B, any reasonable number of these components or elements may be included in the communication system 100.

The EDs 110a-110d are configured to operate, communicate, or both, in the communication system 100. For example, the EDs 110a-110d are configured to transmit, receive, or both, via wireless or wired communication channels. Each ED 110a-110d represents any suitable end user device for wireless operation and may include such devices (or may be referred to) as a user equipment/device (UE), wireless transmit/receive unit (WTRU), mobile station, fixed or mobile subscriber unit, cellular telephone, station (STA), machine type communication (MTC) device, personal digital assistant (PDA), smartphone, laptop, computer, tablet, wireless sensor, or consumer electronics device.

In FIG. 1B, the RANs 120a-120b include base stations 170a-170b, respectively. Each base station 170a-170b is configured to wirelessly interface with one or more of the EDs 110a-110c to enable access to any other base station 170a-170b, the core network 130, the PSTN 140, the internet 150, and/or the other networks 160. For example, the base stations 170a-170b may include (or be) one or more of several well-known devices, such as a base transceiver station (BTS), a Node-B (NodeB), an evolved NodeB (eNodeB), a Home eNodeB, a gNodeB, a transmission and receive point (TRP), a site controller, an access point (AP), or a wireless router.

In some examples, one or more of the base stations 170a-170b may be a terrestrial base station that is attached to the ground. For example, a terrestrial base station could be mounted on a building or tower. Alternatively, one or more of the base stations 172 may be a non-terrestrial base station, or non-terrestrial TRP (NT-TRP), that is not attached to the ground. A flying base station is an example of the non-terrestrial base station. A flying base station may be implemented using communication equipment supported or carried by a flying device. Non-limiting examples of flying devices include airborne platforms (such as a blimp or an airship, for example), balloons, quadcopters and other aerial vehicles. In some implementations, a flying base station may be supported or carried by an unmanned aerial system (UAS) or an unmanned aerial vehicle (UAV), such as a drone or a quadcopter. A flying base station may be a moveable or mobile base station that can be flexibly deployed in different locations to meet network demand. A satellite base station is another example of a non-terrestrial base station. A satellite base station may be implemented using communication equipment supported or carried by a satellite. A satellite base station may also be referred to as an orbiting base station.

Any ED 110a-110d may be alternatively or additionally configured to interface, access, or communicate with any other base station 170a-170b, the internet 150, the core network 130, the PSTN 140, the other networks 160, or any combination of the preceding.

The EDs 110a-110d and base stations 170a-170b, 172 are examples of communication equipment that can be configured to implement some or all of the operations and/or embodiments described herein. In the embodiment shown in FIG. 1B, the base station 170a forms part of the RAN 120a, which may include other base stations, base station controller(s) (BSC), radio network controller(s) (RNC), relay nodes, elements, and/or devices. Any base station 170a, 170b may be a single element, as shown, or multiple elements, distributed in the corresponding RAN, or otherwise. Also, the base station 170b forms part of the RAN 120b, which may include other base stations, elements, and/or devices. Each base station 170a-170b transmits and/or receives wireless signals within a particular geographic region or area, sometimes referred to as a “cell” or “coverage area”. A cell may be further divided into cell sectors, and a base station 170a-170b may, for example, employ multiple transceivers to provide service to multiple sectors. In some embodiments, there may be established pico or femto cells where the radio access technology supports such. In some embodiments, multiple transceivers could be used for each cell, for example using multiple-input multiple-output (MIMO) technology. The number of RAN 120a-120b shown is exemplary only. Any number of RAN may be contemplated when devising the communication system 100.

The base stations 170a-170b, 172 communicate with one or more of the EDs 110a-110c over one or more air interfaces 190a, 190c using wireless communication links e.g. radio frequency (RF), microwave, infrared (IR), etc. The air interfaces 190a, 190c may utilize any suitable radio access technology. For example, the communication system 100 may implement one or more orthogonal or non-orthogonal channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a, 190c.

A base station 170a-170b,172 may implement Universal Mobile Telecommunication System (UMTS) Terrestrial Radio Access (UTRA) to establish an air interface 190a, 190c using wideband CDMA (WCDMA). In doing so, the base station 170a-170b.172 may implement protocols such as High Speed Packet Access (HSPA), Evolved HPSA (HSPA+) optionally including High Speed Downlink Packet Access (HSDPA), High Speed Packet Uplink Access (HSPUA) or both. Alternatively, a base station 170a-170b,172 may establish an air interface 190a,190c with Evolved UTMS Terrestrial Radio Access (E-UTRA) using LTE, LTE-A, and/or LTE-B. It is contemplated that the communication system 100 may use multiple channel access operation, including such schemes as described above. Other radio technologies for implementing air interfaces include IEEE 802.11, 802.15, 802.16, CDMA2000, CDMA2000 1×, CDMA2000 EV-DO, IS-2000, IS-95, IS-856, GSM, EDGE, and GERAN. Of course, other multiple access schemes and wireless protocols may be utilized.

The RANs 120a-120b are in communication with the core network 130 to provide the EDs 110a-110c with various services such as voice, data, and other services. The RANs 120a-120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a-120b or EDs 110a-110c or both, and (ii) other networks (such as the PSTN 140, the internet 150, and the other networks 160).

The EDs 110a-110d communicate with one another over one or more sidelink (SL) air interfaces 190b, 190d using wireless communication links e.g. radio frequency (RF), microwave, infrared (IR), etc. The SL air interfaces 190b, 190d may utilize any suitable radio access technology, and may be substantially similar to the air interfaces 190a, 190c over which the EDs 110a-110c communication with one or more of the base stations 170a-170b, or they may be substantially different. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the SL air interfaces 190b, 190d. In some embodiments, the SL air interfaces 180 may be, at least in part, implemented over unlicensed spectrum.

In addition, some or all of the EDs 110a-110d may include operation for communicating with different wireless networks over different wireless links using different wireless technologies and/or protocols. Instead of wireless communication (or in addition thereto), the EDs may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as internet protocol (IP), transmission control protocol (TCP) and user datagram protocol (UDP). EDs 110a-110d may be multimode devices capable of operation according to multiple radio access technologies, and incorporate multiple transceivers necessary to support multiple radio access technologies.

In some embodiments, the signal is transmitted from a terrestrial BS to the UE or transmitted from the UE directly to the terrestrial BS and in both cases the signal is not reflected by a RIS. However, the signal may be reflected by the obstacles and reflectors such as buildings, walls and furniture. In some embodiments, the signal is communicated between the UE and a non-terrestrial BS such as a satellite, a drone and a high altitude platform. In some embodiments, the signal is communicated between a relay and a UE or a relay and a BS or between two relays. In some embodiments, the signal is transmitted between two UEs. In some embodiments, one or multiple RIS are utilized to reflect the signal from a transmitter and a receiver, where any of the transmitter and receiver includes UEs, terrestrial or non-terrestrial BS, and relays.

FIG. 2 illustrates another example of an ED 110 and network devices, including a base station 170a, 170b (at 170) and an NT-TRP 172. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 2, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 2A or 2B). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 210 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distributed unit (DU), positioning node, among other possibilities. The T-TRP 170 may be macro BSs, pico BSs, relay node, donor node, or the like, or combinations thereof. The T-TRP 170 may refer to the forging devices, or to apparatus (e.g. communication module, modem, or chip) in the forgoing devices. While the figures and accompanying description of example and embodiments of the disclosure generally use the terms AP, BS, and AP or BS, it is to be understood that such device could be any of the types described above.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. multiple-input multiple-output (MIMO) precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

One or more steps of the embodiment methods provided herein may be performed by corresponding units or modules, according to FIG. 2. FIG. 2 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

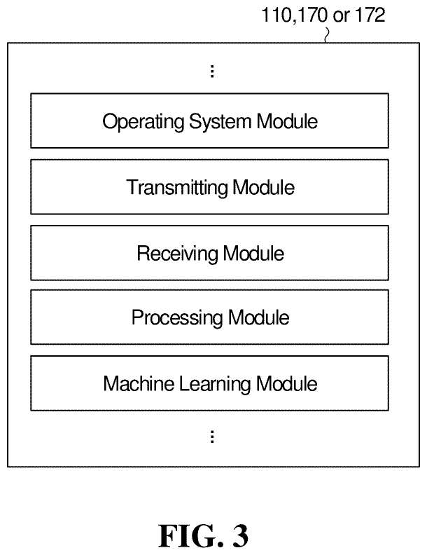

One or more steps of the embodiment methods provided herein may be performed by corresponding units or modules, according to FIG. 3. FIG. 3 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

For future wireless networks, a number of the new devices could increase exponentially with diverse functionalities. Also, many new applications and new use cases in future wireless networks than existing in 5G may emerge with more diverse quality of service demands. These will result in new key performance indications (KPIs) for the future wireless network (for an example, 6G network) that can be extremely challenging, so the sensing technologies, and AI technologies, especially ML (deep learning) technologies, had been introduced to telecommunication for improving the system performance and efficiency.

AI/ML technologies applied communication including AI/ML communication in Physical layer and AI/ML communication in media access control (MAC) layer. For physical layer, the AI/ML communication may be useful to optimize the components design and improve the algorithm performance, like AI/ML on channel coding, channel modelling, channel estimation, channel decoding, modulation, demodulation, MIMO, waveform, multiple access, PHY element parameter optimization and update, beam forming & tracking and sensing & positioning, etc. For MAC layer, AI/ML communication may utilize the AI/ML capability with learning, prediction and make decisions to solve the complicated optimization problems with better strategy and optimal solution, for example to optimize the functionality in MAC, e.g. intelligent TRP management, intelligent beam management, intelligent channel resource allocation, intelligent power control, intelligent spectrum utilization, intelligent modulation and coding scheme (MCS), intelligent hybrid automatic repeat request (HARQ) strategy, intelligent transmit/receive (Tx/Rx) mode adaption, etc.

AI/ML architectures usually involve multiple nodes, which can be organized in two modes, i.e., centralized and distributed, both of which can be deployed in access network, core network, or an edge computing system or third-party network. The centralized training and computing architecture is restricted by huge communication overhead and strict user data privacy. Distributed training and computing architecture comprise several frameworks, e.g., distributed machine learning and federated learning. AI/ML architectures comprises intelligent controller which can perform as single agent or multi-agent, based on joint optimization or individual optimization. A new protocol and signaling mechanism is needed so that the corresponding interface link can be personalized with customized parameters to meet particular requirements while minimizing signaling overhead and maximizing the whole system spectrum efficiency by personalized AI technologies.

Further terrestrial and non-terrestrial networks can enable a new range of services and applications such as earth monitoring, remote sensing, passive sensing and positioning, navigation, and tracking, autonomous delivery and mobility. Terrestrial networks based sensing and non-terrestrial networks based sensing could provide intelligent context-aware networks to enhance the UE experience. For example, terrestrial networks based sensing and non-terrestrial networks based sensing may involve opportunities for localization and sensing applications based on a new set of features and service capabilities. Applications such as THz imaging and spectroscopy have the potential to provide continuous, real-time physiological information via dynamic, non-invasive, contactless measurements for future digital health technologies. Simultaneous localization and mapping (SLAM) methods will not only enable advanced cross reality (XR) applications but also enhance the navigation of autonomous objects such as vehicles and drones. Further in terrestrial and non-terrestrial networks, the measured channel data and sensing and positioning data can be obtained by the large bandwidth, new spectrum, dense network and more light-of-sight (LOS) links. Based on these data, a radio environmental map can be drawn through AI/ML methods, where channel information is linked to its corresponding positioning or environmental information to provide an enhanced physical layer design based on this map.

Sensing coordinators are nodes in a network that can assist in the sensing operation. These nodes can be standalone nodes dedicated to just sensing operations or other nodes (for example TRP 170, ED 110, or core network node) doing the sensing operations in parallel with communication transmissions. A new protocol and signaling mechanism is needed so that the corresponding interface link can be performed with customized parameters to meet particular requirements while minimizing signaling overhead and maximizing the whole system spectrum efficiency.

AI/ML and sensing methods are data-hungry. In order to involve AI/ML and sensing in wireless communications, more and more data are needed to be collected, stored, and exchanged. The characteristics of wireless data expand quite large ranges in multiple dimensions, e.g., from sub-6 GHz, millimeter to Terahertz carrier frequency, from space, outdoor to indoor scenario, and from text, voice to video. These data collecting, processing and usage operations are performed in a unified framework or a different framework.

Control information is referenced in some embodiments herein. Control information may sometimes instead be referred to as control signaling, or signaling. In some cases, control information may be dynamically communicated, e.g. in the physical layer in a control channel, such as in a physical uplink control channel (PUCCH) or physical uplink shared channel (PUSCH) or physical downlink control channel (PDCCH). An example of control information that is dynamically indicated is information sent in physical layer control signaling, e.g., uplink control information (UCI) sent in a PUCCH or PUSCH or downlink control information (DCI) sent in a PDCCH. A dynamic indication may be an indication in a lower layer, e.g., physical layer/layer 1 signaling, rather than in a higher-layer (e.g. rather than in RRC signaling or in a MAC CE). A semi-static indication may be an indication in semi-static signaling. Semi-static signaling, as used herein, may refer to signaling that is not dynamic, e.g. higher-layer signaling (such as RRC signaling), and/or a MAC CE. Dynamic signaling, as used herein, may refer to signaling that is dynamic, e.g., physical layer control signaling sent in the physical layer, such as DCI sent in a PDCCH or UCI sent in a PUCCH or PUSCH.

Aspects of the present disclosure provide apparatuses, devices, and methods for configuring and/or indicating an RS pattern that may have low RS-related signaling overhead (e.g., low RS configuration or RS indication overhead). In some embodiments, the methods may be flexible in respect of generating arbitrary RS patterns and mapping resource elements used for the RS to one or more resource zones and may be applicable to ultra wide bandwidth (UWB) cases.

In some embodiments, the RS patterns that are being configured may be used by the UE to know when RS is being transmitted by the BS so the UE knows when to expect to receive. In some embodiments, the RS patterns that are being configured may be used by the UE to know when to transmit RS to the BS.

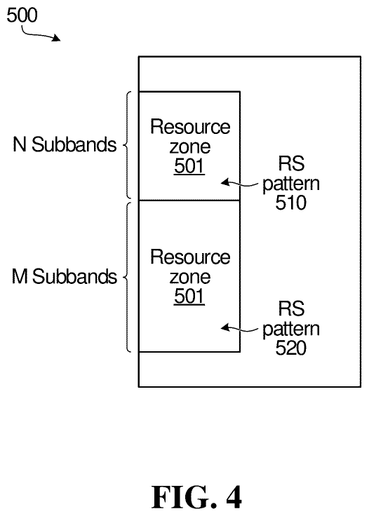

FIG. 4 illustrates a portion of the time and frequency resource having two resource zones in which sparse RS patterns may be used, in accordance with embodiments of the present disclosure. The time and frequency resource 500 may comprise one or more resource zones, such as resource zones 501 and 502. The resource zone 501 may comprise N subbands and the resource zone 502 may comprise M subbands. Each subband may comprise at least one resource block. Subbands correspond to a frequency resource and resource blocks correspond to a time resource. A resource block may include one or more consecutive resource elements, which are a smallest granularity of the frequency resource. While two resource zones are shown in FIG. 4, it is understood that the number of resource zones would be specific to particular implementation.

In some embodiments, the one or more subbands (e.g., one or more subbands of N subbands in the resource zone 501 or one or more subbands of M subbands in the resource zone 502) may comprise at least one resource block group. Each resource block group may include one or more resource blocks (e.g., physical resource block (PRB)). In some embodiments, the number of resource blocks in a resource block group and/or the number of resource block groups in each subband may be configured by a base station (BS).

In some embodiments, at least one RS pattern, such as RS patterns 510 and 520, may be applied to at least one resource block or at least one resource block group in one or more resource zones (e.g., resource blocks in the resource zones 501 and/or 502). In some embodiments, the resource zones (e.g., resource zones 501 and 502) may be a transmission time and/or frequency window, which may be configured by a BS. In some embodiments, the RS pattern within the resource zones (e.g., RS pattern within a configured transmission time and/or frequency window) may include an RS pattern for one or more subbands.

In some embodiments, at least one RS pattern may be configured as a basic RS pattern. The basic RS pattern may comprise a particular density of resource elements in a resource zone (e.g., resource zone 501 or 502), or a particular density of resource elements in the configured time and/or frequency window that are used for RS transmission. The density may also be referred to as sparsity. The basic RS pattern may indicate particular resource elements of a resource block, or a resource block group, used for the RS or the RS transmission, whereby the resource block may comprise one or more resource elements (e.g., 12 resource elements). In some embodiments, one or more basic RS patterns may be predetermined or preconfigured. The one or more basic RS patterns may then be used to determine an arbitrary RS pattern for a particular occurrence in time. For example, the pattern of a basic RS pattern may be shifted, so the density of resource elements having a RS is the same, but the RS occurs at different locations, or the pattern of a basic RS pattern may be scaled so the density is greater or less than that of the basic RS pattern.

In some embodiments, an RS pattern may be configured, for example by a BS, per subband. In some embodiments, an RS pattern may be specific to a particular subband. The RS pattern for a certain subband may comprise a combination of multiple RS patterns, for example a combination of multiple basic RS patterns.

In some embodiments, a reference RS pattern may be configured, in which the reference pattern is comprised of one basic RS pattern. In some embodiments, the reference RS pattern may be comprised of multiple basic RS patterns. In some embodiments, one or more reference RS pattern may be configured, in which each reference RS pattern is comprised of one or more basic RS patterns.

The reference RS pattern may be used to update, or modify, one or more RS patterns used for transmission of the RS. In some embodiments, the reference RS pattern may be configured to serve as a reference pattern, for example, to update the reference RS pattern currently applied to a resource zone (e.g., RS patterns 510 and 520 applied to resource blocks in the resource zones 501 and 502) or indicate a reference RS pattern to be applied to the resource zone. In some embodiments, reference RS patterns may be updated or modified by enabling or disabling particular resource elements or particular resource blocks for transmission of the RS in the reference RS pattern. In some embodiments, reference RS patterns may be updated or modified using a time and/or a frequency offset(s) to a reference point in the reference RS pattern. In some embodiments, the reference point may be a start point or an end point of a subband. In some embodiments, the start point and end point of the subband may be determined based on a numerology (subcarrier spacing) configuration.

According to some embodiments, a BS may transmit, to a user equipment (UE), configuration information to be used in conjunction with at least one RS pattern, which may be applied to one or more resource zones. The RS pattern may be used to determine when transmission of an RS occurs in a resource zone comprising at least one subband. The UE may determine when the RS is to be transmitted or received by the UE based on at least one of the RS pattern or the configuration information. In some embodiments, the BS may also transmit, to the UE, the RS pattern indicating one or more particular resource elements of a resource block used for the RS.

According to some embodiments, the configuration information may be used in conjunction with a non-uniform RS pattern. In some embodiments, the non-uniform RS pattern may be a basic RS pattern. The configuration information for the non-uniform RS pattern may comprise a number of resource block groups in a subband or a number of resource blocks in each resource block group. It may be noted that, in some embodiments, a resource block group may be considered a basic unit for RS configuration. Put another way, an RS pattern (e.g., basic RS pattern) may be configured on a basis of a resource block group which includes one or more resource blocks.

In some embodiments, the configuration information for the non-uniform RS pattern may indicate a starting resource block (or starting resource block group) and an ending resource block (or ending resource block group). The starting resource block (or starting resource block group) may indicate one end (a first end) of a subband, and the ending resource block (or ending resource block group) may indicate the other end (a second end) of the subband.

In some embodiments, the configuration information for the non-uniform RS pattern may comprise RS resource block information. The RS resource block information may indicate one or more resource blocks that include at least one RS. In some embodiments, the RS resource block information may also indicate one or more resource blocks that do not include any RS. It may be noted that, in some embodiments, the configuration information for the non-uniform RS pattern may only include RS resource block information that indicates resource blocks including RS.

In some embodiments, the RS resource block information may comprise a bitmap. In such embodiments, the resource blocks or resource block groups that include at least one RS may be indicated in the bitmap by a first type of bit (e.g., a non-zero bit), and the resource blocks that do not include any RS may be indicated in the bitmap by a second type of bit (e.g., a zero bit). For example, the first type of bit having a bit value ‘1’ in the bitmap may indicate a resource block or a resource block group with a non-zero RS, or in other words, indicate that the resource block or the resource block group includes at least one RS. The second type of bit having a bit value ‘o’ in the bitmap may indicate a resource block or a resource block group with no RS. Alternatively, the non-zero bit and the zero bit may be oppositely associated with resource block or resource block group having a non-zero RS or zero RS to that described above.

In some embodiments, the configuration information for the non-uniform RS pattern may comprise an indication to partition a wide band or an ultra wide band (UWB) into a plurality of subbands, each of which may be configured individually.

The RS may be transmitted or received according to the RS resource block information. For example, a UE may transmit an RS using resource blocks that are configured to include at least one RS, as is indicated in the RS resource block information or the configuration information.

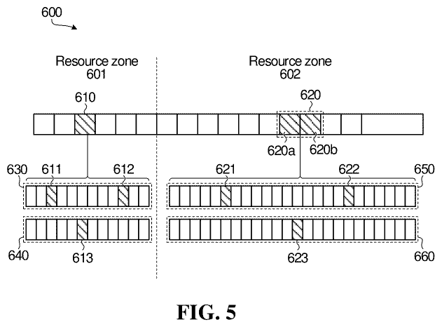

FIG. 5 illustrates an example of a bitmap 600, where each bit of the bitmap corresponds to a particular resource block comprising 12 resource elements, and where a crosshatched bit, for example bit 610, indicates that the resource block includes an RS pattern, in accordance with embodiments of the present disclosure.

Referring to FIG. 5, a bitmap 600 is shown to include a plurality of bits that correspond to resource blocks in two resource zones, resource zone 601 and resource zone 602. The bitmap 600 may be used to indicate configuration information that is used to determine when transmission of an RS signal occurs in each resource zone 601 and 602. Here, for the purpose of illustration, the configuration information associated with the resource zone 601 is referred to as the first configuration information, and the configuration information associated with the resource zone 602 is referred to as the second configuration information.

Each bit of the bitmap 600 corresponds to a resource block or a resource block group.

The first configuration information associated with the resource zone 601 may comprise RS resource block information. The RS resource block information of the first configuration information may indicate the resource block used for transmission of at least one RS (or the resource block that includes at least one RS). The RS resource block information of the first configuration information indicates, using a certain bit value (e.g., ‘1’), a resource block corresponding to bit 610 is used for transmission of the RS. The other resource blocks that correspond to the other bits of the bitmap corresponding to resource zone 601 are not used for the RS transmission in the resource zone 601 and may be indicated in the bitmap 600 by another bit value (e.g., ‘o’).

The first configuration information may be used in conjunction with at least one RS pattern, such as the RS patterns 630 and 640. Each of the RS patterns 630 and 640 may be a basic RS pattern. The RS pattern 630 may indicate that the resource elements 611 and 612 when applied in the resource block are used for the RS, and the RS pattern 640 may indicate that only the resource element 613 when applied in the resource block is used for the RS.

The second configuration information associated with the resource zone 602 may comprise RS resource block information. The RS resource block information of the second configuration information may indicate the resource block group used for transmission of at least one RS (or the resource block group that includes at least one RS). The second configuration information may include information indicative of the number of resource blocks in the resource block group comprised of two adjacent resource blocks, corresponding to bits of bitmap 600, i.e. bits 620a and 620b, collectively bits 620. The second configuration information may include information indicative of the starting resource block 620a and/or the ending resource block 620b. The RS resource block information of the second configuration information indicates, using a certain bit value (e.g., ‘1’), a resource block group corresponding to bits 620 is used for transmission of at least one RS. The other resource block groups that correspond to the other bits of the bitmap corresponding to resource zone 602 are not used for the RS transmission in the resource zone 602 and may be indicated in the bitmap 600 by another bit value (e.g., ‘o’).

The second configuration information may be used in conjunction with at least one RS pattern, such as the RS patterns 650 and 660. Each of the RS patterns 650 and 660 may be a basic RS pattern. The RS pattern 650 may indicate that the resource elements 621 and 622 when applied in the resource block group are used for the RS, and the RS pattern 660 may indicate that only the resource element 623 when applied in the resource block group is used for the RS.

In some cases, the location of RSs may be shifted from the location of RS indicated for a basic RS pattern or another reference RS pattern in the configuration information. According to some embodiments, the shifted location of the RS may be indicated using the configuration information to be used in conjunction with the basic RS pattern (or the other reference RS pattern). Hereinafter, only the basic RS pattern may be mentioned for the purpose of illustrating configuration of the shifted location of the resource elements used for the RS. However, in some embodiments, another reference RS pattern may be used to indicate the shifted location of the resource elements used for the RS.

As noted above, in some embodiments, the shifted location of the RS may be indicated to the UE using the configuration information to be used in conjunction with the basic RS pattern. For this, the configuration information used in conjunction with the basic RS pattern may comprise RS pattern modification information or RS pattern mapping information. In some embodiments, the RS pattern modification information or the RS pattern mapping information may comprise pattern shift information, which indicates a shift of location of the resource elements used for the RS (e.g., transmission or reception of the RS).

In some embodiments, the pattern shift information may comprise a pattern shift index corresponding to a shift of the RS from an old resource element indicated in an RS pattern, for example a basic RS pattern, to a new resource element. In some embodiments, the location of the new resource element may be explicitly indicated by the pattern shift. In some embodiments, the location of the new resource element may be determined using the pattern shift index in reference to the location of the old resource element indicated in the RS pattern. In other words, the location of the new resource element may be a location of the resource element shifted, by the pattern shift index, from the location of the old resource element.

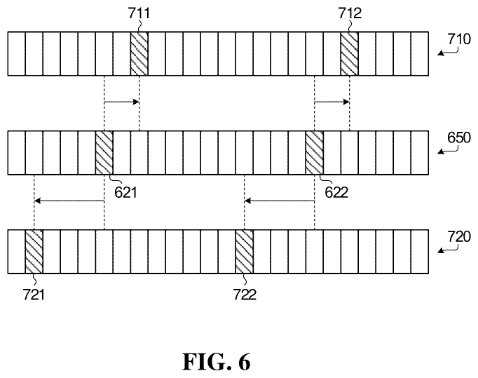

FIG. 6 illustrates an example of particular resource elements of a plurality of resource elements, some of the resource elements include one or more RSs forming the basic RS pattern 650, and two additional examples 710 and 720 of a corresponding number of resource elements that indicate a shift of the location of the resource elements on which RS occur, forming a reference RS pattern with the same period, in accordance with embodiments of the present disclosure. Referring to FIG. 6, configuration information to be used in conjunction with the basic RS pattern 650 may be provided to a UE. As noted above, the basic RS pattern 650 indicates that the resource elements 621 and 622 are used for one or more RS.

The RS patterns 710 and 720 illustrate the resource elements on which RSs are to occur based on the configuration information associated with the basic RS pattern 650 and pattern shift information. The locations of the one or more RS are shifted from resource elements 621 and 622 in basic pattern 650 to resource elements 711 and 712, respectively in RS pattern 710, which is two resource elements towards the right. Therefore, in the RS pattern 710, the resource elements 711 and 712 are used for the one or more RS (e.g., transmission of the one or more RS). To indicate the shifted locations, in some embodiments, the configuration information may comprise, for example, a pattern shift index. The locations of the resource elements 711 and 712 may be indicated using the pattern shift index with reference to the locations of the resource elements 621 and 622 indicated in the RS pattern 650. For example, the pattern shift index may comprise a value of ‘2’ or ‘+2’, thereby indicating that the locations of the resource elements 711 and 712 are two resource elements shifted towards right from the locations of the resource elements 621 and 622 in the basic RS pattern 650. This way, the locations of the resource elements 711 and 712 may be determined based on the locations of the resource elements 621 and 622 and indicated using the configuration information to be used in conjunction with the RS pattern 650.

On the other hand, in the RS pattern 720, the resource elements 721 and 722 may be used for the one or more RS (e.g., transmission or reception of the RS). The locations of the one or more RS are shifted from resource elements 621 and 622 in basic pattern 650 to the resource elements 721 and 722, respectively in RS pattern 720, which is four resource elements towards the left. To indicate the shifted locations, in some embodiments, the configuration information may comprise, for example, a different pattern shift index from the pattern shift index used for the RS pattern 710. The locations of the resource elements 721 and 722 may be indicated using the pattern shift index with reference to the locations of the resource elements 621 and 622 indicated in the RS pattern 650. For example, the pattern shift index may comprise a value of ‘-4’, thereby indicating that the locations of the resource elements 711 and 712 are four resource elements shifted towards the left from the locations of the resource elements 621 and 622 in basic RS pattern 650. This way, the locations of the resource elements 721 and 722 may be determined based on the locations of the resource elements 621 and 622 and indicated using the configuration information to be used in conjunction with the RS pattern 650. As opposed to using negative values for shifts in a given direction, the total range of shifts in the left and right directions may be assigned a value between 0 and N−1, where N is the total number of shifts, and each shift is assigned a value between 0 and N−1.

In some embodiments, the shift of the pattern, thereby shifting the RSs to different resource elements may be specific to a particular multiple-input-multiple-output (MIMO) layer and/or a particular BS. Therefore, the pattern shift information may be specific to a particular MIMO layer and/or specific to a particular BS.

In some embodiments, the shift of the pattern, thereby shifting the one or more RS to different resource elements may be common for all antenna port or may be specific to a particular antenna port. Therefore, the pattern shift information may be common for all antenna ports or may be specific to a particular antenna port.

In some embodiments, in order to reduce signaling overhead, a set of candidate shift indices may be preconfigured by radio resource control (RRC) signaling. Subsequent to the set of candidate shift indices being received by the UE, a shift index, which may be one of the candidate shift indices, may be selected by the UE or indicated to the UE by the BS via downlink control information (DCI) signaling. Put another way, pattern shift index configuration information comprising a set of candidate shift indices may be received via RRC signaling and the patent shift index indicative of actual shift of the one or more RS or actual shifted location of the one or more RS may be received via DCI signaling. Once the UE has stored a set of candidate shift indices, the BS only needs to send a notification of the selected shift index, thereby reducing the overall amount of overhead. In some embodiments, the pattern shift index configuration information may comprise information indicative of an association between an amount of shift and the pattern shift index. In some embodiments, the pattern shift index configuration information may be part of the pattern shift information.

In some cases, the number of resource elements used for the RS may be different from the number of resource elements of the one or more RS indicated in the configuration information to be used in conjunction with a basic RS pattern or another reference RS pattern. According to some embodiments, the change in the number of resource elements used for the one or more RS may be indicated using the configuration information to be used in conjunction with the basic RS pattern (or the other reference RS pattern). Hereinafter, only the basic RS pattern may be mentioned for the purpose of illustrating configuration of the change in the number of the resource elements used for the RS. However, in some embodiments, another reference RS pattern may be used to indicate the change in the number of the resource elements used for one or more RS.

As noted above, in some embodiments, the change in the number of the resource elements used for the one or more RS may be indicated using the configuration information to be used in conjunction with the basic RS pattern. For this, the configuration information used in conjunction with the basic RS pattern may comprise RS pattern modification information or RS pattern mapping information. In some embodiments, the RS pattern modification information or the RS pattern mapping information may comprise RS pattern density change information, which indicates the change in the number of resource elements used for the one or more RS as compared to the basic RS pattern.

In some embodiments, the RS pattern density change information may comprise a pattern density change to indicate a change in density of the one or more RS in comparison to the basic RS pattern. For example, the change in density of the one or more RS or the change in the number of resource elements used for the one or more RS may be indicated using an integer (e.g., increased density or decreased density by K times (K=integer)), in comparison to the basic RS pattern.

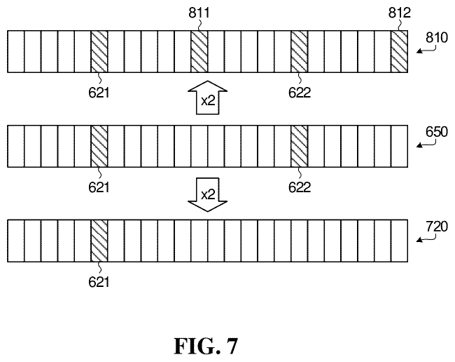

FIG. 7 illustrates an example of particular resource elements of a plurality of resource elements, in which two of the resource elements include one or more RSs forming a basic RS pattern, and two additional examples of a corresponding number of resource elements with a change in the number of resource elements that include the one or more RS, thereby changing the density of the RS pattern, in accordance with embodiments of the present disclosure. Referring to FIG. 7, configuration information to be used in conjunction with the RS pattern 650 may be provided to a UE. As noted above, the basic RS pattern 650 indicates that the resource elements 621 and 622 are used for one or more RS.

The RS patterns 810 and 820 are based on the configuration information to be used in conjunction with basic RS pattern 650 and RS pattern density change information. In the RS pattern 810, the density of the one or more RS is increased by ‘2’ in comparison to the density of the one or more RS in the RS pattern 650. Therefore, the resource elements used in the RS pattern are the resource elements 621, 622, 811, and 812. In some embodiments, an increase in the density of the one or more RS may be indicated using an integer (e.g., ‘2’). In some embodiments, an increase in the density of the one or more RS may be indicated using an integer to indicate the scale of the increase and another integer or symbol or bit to indicate a multiplication function (e.g., ‘×2’). On the other hand, in the RS pattern 820, the density of the RS is decreased by ‘2’ in comparison to the density of the one or more RS in the RS pattern 650. This means that only one resource element, the resource element 621, may be used for the one or more RS. In some embodiments, such a decrease in the density of the one or more RS may be indicated using an integer (e.g., ‘−2’). In some embodiments, a decrease in the density of the one or more RS may be indicated using an integer to indicate the scale of the decrease and another integer or symbol or bit to indicate a division function (e.g., ‘=2’). As opposed to using multiplication and division functions to represent changes in density as described above, the total range of positive (increasing density) and negative (decreasing density) density change values may be assigned a value between 0 and N−1, where N is the total number of density changes, and each density change is assigned a value between 0 and N−1.

In some embodiments, the density of the RS may be selected to be one of multiple candidate RS density values configured for each resource zone. In a particular example, when there are two resource zones, the first resource zone with N subbands and the second resource zone with M subbands, each of the first and second resource zones may be configured with one or more candidate RS density values. When the bandwidth of the N subbands is less than a threshold bandwidth and the bandwidth of the M subbands is greater than the threshold bandwidth, the candidate RS density values that may be configured for the first resource zone may be 2, 3, and 4 (i.e., ∈{2,3,4}) and the candidate RS density values that may be configured for the second resource zone may be 6, 7, and 8 (i.e., ∈{6,7,8}). In some embodiments, the candidate RS density values configured for one resource zone may be based on the candidate RS density values configured for another resource zone. For example, when the bandwidth of the N subbands is less than the bandwidth of the M subbands, the candidate RS density values configured for the second resource zone may be comparable to the candidate RS density values for the first resource zone, but increased by a predetermined value (i.e., candidate RS density values for the second resource zone=candidate RS density values for the first resource zone+Δ).

In some embodiments, the RS pattern density change information may be specific to a particular antenna port. In some embodiments, the RS pattern density change information may be indicated per antenna port.

In some embodiments, the RS pattern density change information may be associated with at least one of the resource zone size or the number of subbands in the resource zone.

In some embodiments, the configuration may include RS shift information and RS pattern density change information. In this way, an RS pattern may have both a shift for the location of the one or more RS and a change in density as compared to a basic RS pattern.

In some embodiments, the reference RS configuration information to be used in conjunction with the basic RS pattern to determine a reference RS pattern may comprise information indicative of a potential maximum number of resource elements in an RS pattern in respect of time, frequency, and/or spatial domains. The information indicative of the potential maximum number of resource elements in the RS pattern may be configured via RRC signaling. For example, the reference RS configuration information comprising the information indicative of the potential maximum number of resource elements may be transmitted to a UE via RRC signaling.

In some embodiments, some reference RS patterns may be even. Put another way, resource elements used for at least one RS may be evenly or regularly distributed in the reference RS pattern. In some embodiments, some reference RS patterns may be uneven. Put another way, resource elements used for at least one RS may be unevenly or irregularly distributed in the reference RS pattern.

In some embodiments, the reference RS configuration information to be used in conjunction with the basic RS pattern to determine a reference RS pattern may comprise information indicative of potential resource elements that may be used for at least one RS only in time and frequency domains. As such, information indicative of a mapping between resource elements used for the at least one RS in an RS pattern and one or more antenna ports may be further updated or configured via media access control-control element (MAC-CE) signaling or downlink control information (DCI) signaling. For example, the configuration information to be used in conjunction with the RS pattern may include RS pattern modification information or RS pattern mapping information comprising antenna port mapping information. The antenna port mapping information may be indicative of a mapping of the at least one RS in the reference RS pattern and one or more antenna ports and may be transmitted to a UE via MAC-CE signaling or DCI signaling.

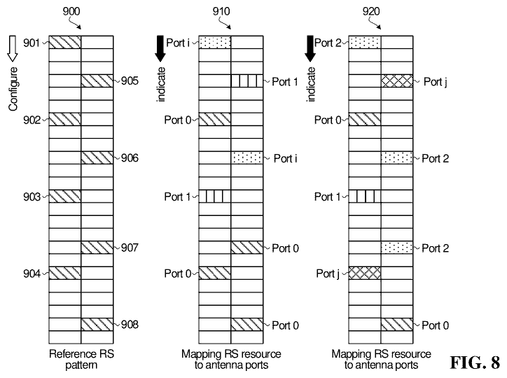

FIG. 8 illustrates an example of mapping of a reference RS pattern for a time and frequency resource and two examples of how the pattern may be applied to map RS resources to one or more antenna ports, in accordance with embodiments of the present disclosure. As shown in FIG. 8, there may be a basic RS pattern used to configure a reference RS pattern 900. Then a subset of resource elements 901, 902, 903, 904, 905, 906, 907, and 908 of the entire set of resource elements may be used for at least one RS in the reference RS pattern 900. Reference RS patterns 910 and 920 show how RSs for different antenna ports may be mapped on to the resource elements intended for at least one RS indicated in the reference RS pattern 900. For example, based on the antenna port mapping information, resource elements corresponding to the resource elements 902, 904, 907 and 908 of reference pattern 900 are mapped to antenna port o, resource elements corresponding to the resource elements 903 and 905 of reference pattern 900 are mapped to antenna port 1, and resource elements corresponding to the resource elements 901 and 906 of reference pattern 900 are mapped to antenna port i. The mapping enables the UE to know which resource elements are used for different antenna ports in time, frequency, and spatial domains. In some cases, further antenna port mapping information may be transmitted to a UE so that the reference RS pattern 910 may be further modified or updated to the RS pattern 920. Upon receiving the further antenna port mapping information, resource elements corresponding to the resource elements 901, 906 and 907 of reference pattern 900 are mapped to antenna port 2, and resource elements corresponding to the resource elements 904 and 905 of reference pattern 900 are mapped to antenna port j. The updated mapping information enables the UE to know which resource elements are to be used for different antenna ports in time, frequency, and spatial domains based on the further antenna port mapping information.

In some embodiments, configuration information pertaining to RS pattern information may be used for configuring an RS pattern that may be used for channel acquisition or demodulation for data transmission (e.g., RS pattern for channel state information reference signal (CSI-RS), RS pattern for sounding reference signal (SRS), RS pattern for demodulation reference signal (DMRS)). This configuration information may be configured via DCI signaling. For example, the configuration information to be used in conjunction with the RS pattern may include RS pattern modification information or RS pattern mapping information comprising enabling/disabling RS information. The enabling/disabling RS information may indicate that particular resource elements of the RS pattern are enabled (activated) or disabled (deactivated) for transmission of the at least one RS in the RS pattern, and may be transmitted to a UE via DCI signaling.

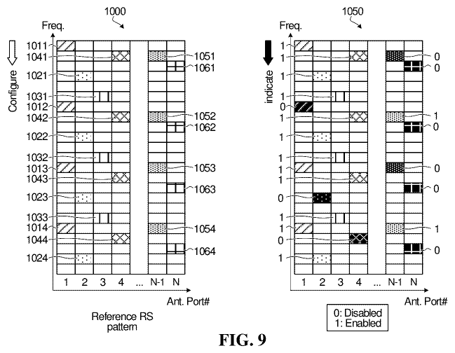

FIG. 9 illustrates an example of an RS pattern that is used to configure at least one RS on multiple antenna ports and how the RS pattern may be used to indicate particular resource elements in the pattern are either enabled or disabled for transmission of the RS in an RS pattern, in accordance with embodiments of the present disclosure. As shown in FIG. 9, there may be a basic RS pattern configured as a reference RS pattern 1000. The resource elements configured for at least one RS are indicated in the RS pattern 1000. In some embodiments, the reference RS pattern 1000 may be used for channel acquisition or demodulation for data transmission (e.g., RS pattern for CSI-RS, SRS, and/or DMRS). The resource elements used for the at least one RS are mapped to antenna ports as shown in FIG. 9. Specifically, the resource elements 1011, 1012, 1013, and 1014 are mapped to antenna port 1, the resource elements 1021, 1022, 1023, and 1024 are mapped to antenna port 2, the resource elements 1031, 1032, and 1033, are mapped to antenna port 3, the resource elements 1041,1042, 1043, and 1044 are mapped to antenna port 4, . . . , the resource elements 1051, 1052, 1053, and 1054 are mapped to antenna port N−1, and the resource elements 1061, 1062, 1063 and 1064 are mapped to antenna port N. In some embodiments, these resource elements may be mapped to the respective antenna ports based on antenna port mapping information included in the reference RS configuration information to be used in conjunction with the RS pattern 1000.

In some embodiments, the resource elements in the reference RS pattern 1000 may be enabled or disabled for transmission of the at least one RS based on enabling/disabling RS information in configuration information to be used in conjunction with the RS pattern and antenna port mapping information. The enabling/disabling RS information may be represented by a first bit type as enabling at least one RS on a particular resource element and a second bit type as disabling at least one RS on a particular resource element. For example, the first bit type for indicating a resource element is enabled may be a bit equal to 1 and the second bit type for indicating a resource element is disabled may be a bit equal to 0. Upon applying the enabling/disabling RS information, an RS pattern 1050 illustrates how some resource elements are enabled for transmission or reception of the at least one RS and some other resource elements are disabled for transmission or reception of the at least one RS. Specifically, the RS pattern 1050 shows how, based on the enabling/disabling RS information and the reference RS pattern 1000, the resource elements in RS pattern 1050 correspond to resource elements 1012, 1023, 1044, 1051, 1053, and 1061 to 1064 that are disabled (or deactivated), and the other resource elements 1011, 1013, 1014, 1021, 1022, 1024, 1031 to 1033, 1041 to 1043, 1052, and 1054 are enabled (or activated) for transmission or reception of the at least one RS (e.g., CSI-RS, SRS, DMRS).

According to some embodiments, the transmission bandwidth for the RS may be common for all configured RS ports within an RS resource set or a resource zone associated with an RS pattern. In some embodiments, configuration information to be used in conjunction with an RS pattern may comprise information indicative of a starting point of the RS and/or transmission bandwidth for the RS. In some embodiments, the configuration information may include a starting resource block indicating a first end of the subband in the resource zone and an ending resource block indicating a second end of the subband in the resource zone. In some embodiments, the configuration information may include a reference point for a start of the at least one RS and a transmission bandwidth for the at least one RS. In some embodiments, the reference point for the start of the at least one RS may be the same as a start point of the RS. In some embodiments, the reference point for start of the at least one RS may be configured as an offset to a particular point that is common for the system resource.

According to some embodiments, multiple basic RS patterns may be combined in one subband as one RS pattern. In some embodiments, the multiple basic RS patterns may include the same RS pattern repeated more than once. In some embodiments, the multiple basic RS patterns may include at least two different basic RS patterns with at least one basic RS pattern repeated more than once. Here, the at least two different basic RS patterns may be configured to have different update periodicities. For example, a first basic RS pattern (e.g., basic RS pattern #1) may be configured via RRC signaling and the other basic RS patterns (e.g., basic RS patterns #2 to #M) may be configured via MAC-CE signaling or physical downlink control channel (PDCCH). In another example, multiple basic RS patterns (e.g., basic RS patterns #1 to #M) may be configured via RRC signaling and the combination of the basic RS patterns may be configured via MAC-CE signaling. Here, one of the basic RS patterns (e.g., basic RS pattern #1) may be used or configured as a default RS pattern.

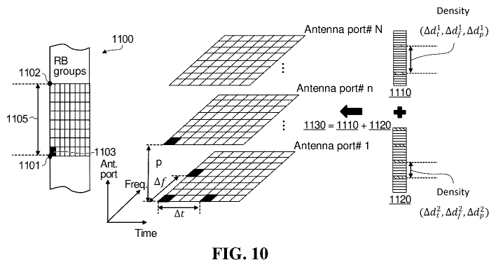

FIG. 10 illustrates an example of indicating particular resource elements of a time and frequency resource block, across multiple antenna ports, that are used for at least one RS using multiple basic RS patterns, in accordance with embodiments of the present disclosure. As illustrated in FIG. 10, a first basic RS pattern 1110 and a second basic RS pattern 1120 may be used in combination to form a reference RS pattern 1130.

The basic RS pattern 1110 may comprise a particular density of resource elements in the configured RS transmission window in time, frequency, and/or spatial domains. For example, the basic RS pattern 1110 may be configured based on two different density values

$$( Δ {d}_{t}^{1} , Δ {d}_{f}^{1} , Δ {d}_{p}^{1} )$$

and (Δt₁, Δf₁, Δp₁), where

$$( Δ {d}_{t}^{1} , Δ {d}_{f}^{1} , Δ {d}_{p}^{1} )$$

may be indicative of RS density of resource elements in basic RS pattern 1110 having RS in time (t), frequency (f), and spatial (p) domains, respectively, and Δt₁, Δf₁, Δp₁ may be indicative of distance between two resource blocks or resource block groups using RS pattern 1110 in time, frequency, and spatial domains, respectively. Similarly, the basic RS pattern 1120 may be represented by two density values, a density of resource elements in the in basic RS pattern 1120 having RS in time, frequency, and/or spatial domains and density of resource blocks or resource block groups having non-zero RS, i.e. using RS pattern 1120. For example, the basic RS pattern 1120 may be configured with

$$( Δ {d}_{t}^{2} , Δ {d}_{f}^{2} , Δ {d}_{p}^{2} )$$

and (Δt₂,Δf₂, Δp₂), where

$$( Δ {d}_{t}^{2} , Δ {d}_{f}^{2} , Δ {d}_{p}^{2} )$$

may be indicative of RS density in basic RS pattern 1120 in time, frequency, and spatial domains, respectively, for the basic RS pattern 1120, and Δt₂, Δf₂, Δp₂ may be indicative of distance between two resource blocks or resource block groups using RS pattern 1110 in time, frequency, and spatial domains, respectively.

The basic RS patterns 1110 and 1120 may be combined, thereby forming reference RS pattern 1130. The reference RS pattern 1130 may indicate one or more particular resource elements of the resource block used for the at least one RS in the resource zone 1100 in respect of time, frequency and/or spatial domains (spatial domain related to antenna port). The reference RS pattern 1130 may indicate one or more particular resource elements used for the at least one RS at each antenna ports (#1˜#N) or a particular antenna port #n.

The configuration information to be used in conjunction with the reference RS pattern 1130 may comprise information indicative of a starting point 1101 and an ending point 1102 for the RS. The starting point 1101 and the ending point 1102 may indicate the two ends of the subband in the resource zone 1100. Alternatively or in addition, configuration information to be used in conjunction with the combined RS pattern 1130 may comprise information indicative of a reference point 1103 for a start of the at least one RS and a transmission bandwidth 1105 for the at least one RS. As shown in FIG. 10, the reference point 1103 may be the same as the starting point 1101. The reference point 1103 may be configured as an offset to a particular point (not shown in FIG. 10) that is common for the system resource.

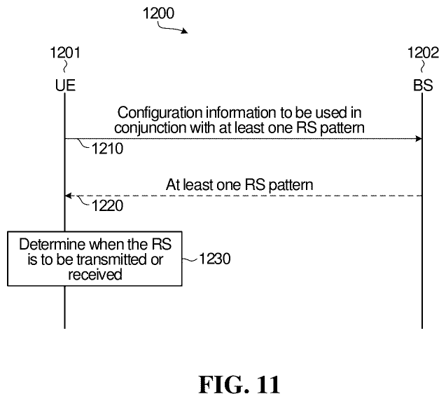

FIG. 11 is a signal flow diagram for signaling between a UE 1201 and a base station (BS) 1202 illustrating an example process for configuring RS patterns used for at least one RS occurring in a resource zone, in accordance with embodiments of the present disclosure.

Referring to FIG. 11, in some embodiments, at step 1210, the BS 1202 may transmit, to the UE 1201, configuration information to be used in conjunction with at least one reference signal (RS) pattern to determine when transmission or reception of an RS signal occurs in a resource zone. The resource zone may comprise at least one subband and each subband may comprise at least one resource block or resource block group.

In some embodiments, the configuration information may comprise one or more of: a number of resource block (RB) groups in a subband of the at least one subband; a number of RBs in each RB group; a starting RB indicating a first end of the subband of the at least one subband; an ending RB indicating a second end of the subband of the at least one subband; a transmission bandwidth for the at least one RS; a reference point for a start of the at least one RS; or an indication to partition a wide band into a plurality of subbands.

In some embodiments, the configuration information may comprise RS pattern modification information or RS pattern mapping information comprising at least one of pattern shift information, RS pattern density change information, RS resource block information, antenna port mapping information, or information indicating enabling/disabling of RS resource elements in an RS pattern.

The pattern shift information may indicate a shift of location of resource elements used for the at least one RS in the at least one RS pattern. In some embodiments, the pattern shift information may comprise a pattern shift index corresponding to a shift of the at least one RS from a first resource element indicated in the at least one RS pattern to a second resource element. In some embodiments, the pattern shift information is at least one of specific to a particular multiple-input-multiple-output (MIMO) layer, or specific to the BS 1202. In some embodiments, the pattern shift information may further comprise pattern shift index configuration information comprising an association between an amount of shift and the pattern shift index. The pattern shift index configuration information may be transmitted from the BS 1202 to the UE 1201 via radio resource control (RRC) signaling and the pattern shift index may be transmitted from the BS 1202 to the UE 1201 via downlink control information (DCI) signaling.

The RS pattern density change information may indicate a change in a number of REs used for the at least one RS within the at least one RS pattern. In some embodiments, the RS pattern density change information may comprise a pattern density change to indicate a change in density of the at least one RS in comparison to the at least one RS pattern. In some embodiments, the RS pattern density change information may be specific to a particular antenna port. In some embodiments, wherein the RS pattern density change information may be associated with at least one of a resource zone size or a number of subbands in the resource zone.

The RS resource block information may indicate resource blocks that include at least one RS. In some embodiments, the RS resource block information may comprise a bitmap. The resource blocks that include at least one RS may be indicated in the bitmap by a first bit and resource blocks that do not include any RS may be indicated by a second bit.

The antenna port mapping information may indicate a mapping of the at least one RS in the at least one RS pattern and one or more antenna ports. In some embodiments, the antenna port mapping information may be transmitted from the BS 1202 to the UE 1201 via media access control-control element (MAC-CE) signaling or DCI signaling.

The information for enabling/disabling of RS resource elements for an RS pattern may indicate particular resource elements of the at least one RS pattern are enabled or disabled for transmission or reception of the at least one RS in the at least one RS pattern.

In some embodiments, at step 1220, the BS 1202 may transmit, to the UE 1201, the at least one RS pattern. Each of the at least one RS pattern may indicate particular resource elements of a resource block used for the at least one RS. The resource block used for the at least one RS may comprise a plurality of resource elements. In some embodiments, the at least one RS pattern may be transmitted from the BS 1202 to the UE 1201 via radio resource control (RRC) signaling. Step 1220 may be an optional step. In some embodiments, the UE made have multiple RS patterns already stored at the UE and the BS may indicate a pattern index that identifies an RS pattern from the multiple RS patterns already stored at the UE for the UE to use at the RS pattern.

Regarding the at least one RS pattern, in some embodiments, multiple RS patterns of the at least one RS pattern may be combined in one subband. The multiple RS patterns may be the same RS pattern repeated more than once, or at least two different RS patterns with at least one RS pattern repeated more than once.

In some embodiments, at step 1230, the UE 1201 may determine when the at least one RS is to be transmitted by the UE 1201 or received by the UE 1201, based on the configuration information received at step 1210 and the at least one RS pattern received at step 1220 above or otherwise notified to the UE 1202.

Subsequent to step 1230, the UE 1201 may transmit at least one RS based on the RS patterns determined in step 1230 or the UE 1201 may receive the at least RS from the BS 1202 based on the RS patterns determined in step 1230.

Examples of devices (e.g., ED or UE and TRP or network device) to perform the various methods described herein are also disclosed. For example, a (first) device may include a memory to store processor-executable instructions, and a processor to execute the processor-executable instructions. When the processor executes the processor-executable instructions, the processor may be caused to perform the method steps of one or more of the devices as described herein, e.g., in relation to FIGS. 4-11. For example, the processor may cause the device to communicate over an air interface in a mode of operation by implementing operations consistent with that mode of operation, e.g. performing necessary measurements and generating content from those measurements, as configured for the mode of operation, preparing uplink transmissions and processing downlink transmissions, e.g. encoding, decoding, etc., and configuring and/or instructing transmission/reception on RF chain(s) and antenna(s).

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a device, apparatus, system or method designed according to an embodiment of this disclosure will not necessarily include all of the features shown in any one of the figures or all of the portions schematically shown in the figures. Moreover, selected features of one example embodiment may be combined with selected features of other example embodiments.

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

1. A method comprising:
receiving configuration information to be used in conjunction with at least one reference signal (RS) pattern to determine when transmission of an RS occurs in a resource zone comprising at least one subband, and each subband of the at least one subband comprises at least one resource block; and
based on the at least one RS pattern and the configuration information, determining when the RS is to be transmitted or received.

2. The method of claim 1, further comprising:
receiving the at least one RS pattern, each of the at least one RS pattern indicating particular resource elements of a resource block used for the RS, wherein the resource block comprises a plurality of resource elements.

3. The method of claim 1, wherein the configuration information indicates at least one of:
a number of resource block (RB) groups in a subband of the at least one subband;
a number of RBs in each RB group;
a starting RB indicating a first end of a subband of the at least one subband;
an ending RB indicating a second end of a subband of the at least one subband;
a transmission bandwidth for the RS;
a reference point for a start of the RS; or
an indication to partition a wide band into a plurality of subbands.

4. The method of claim 1, wherein the configuration information comprises RS pattern modification information or RS pattern mapping information comprising at least one of:
pattern shift information indicating a shift of location of resource elements (REs) used for the RS in the at least one RS pattern;
RS pattern density change information indicating a change in a number of REs used for the RS within the at least one RS pattern;
RS resource block information indicating resource blocks that include at least one RS;
antenna port mapping information indicating a mapping of the RS in the at least one RS pattern and one or more antenna ports; or
enabling or disabling RS information indicating particular REs of the at least one RS pattern are enabled or disabled for transmission of the RS in the at least one RS pattern.

5. The method of claim 4, wherein the RS resource block information comprises a bitmap, and wherein resource blocks that include the at least one RS are indicated in the bitmap by a first bit value, and resource blocks that do not include any RS are indicated by a second bit value.

6. An apparatus comprising:
at least one processor; and
a computer-readable medium having stored thereon, computer executable instructions, that when executed cause the at least one processor to perform operations including:
receiving configuration information to be used in conjunction with at least one reference signal (RS) pattern to determine when transmission of an RS occurs in a resource zone comprising at least one subband, and each subband of the at least one subband comprises at least one resource block; and
based on the at least one RS pattern and the configuration information, determining when the RS is to be transmitted or received.

7. The apparatus of claim 6, the operations further comprising:
receiving the at least one RS pattern, each of the at least one RS pattern indicating particular resource elements of a resource block used for the RS, wherein the resource block comprises a plurality of resource elements.

8. The apparatus of claim 6, wherein the configuration information indicates at least one of:
a number of resource block (RB) groups in a subband of the at least one subband;
a number of RBs in each RB group;
a starting RB indicating a first end of a subband of the at least one subband;
an ending RB indicating a second end of a subband of the at least one subband;
a transmission bandwidth for the RS;
a reference point for a start of the RS; or
an indication to partition a wide band into a plurality of subbands.

9. The apparatus of claim 6, wherein the configuration information comprises RS pattern modification information or RS pattern mapping information comprising at least one of:
pattern shift information indicating a shift of location of resource elements (REs) used for the RS in the at least one RS pattern;
RS pattern density change information indicating a change in a number of REs used for the RS within the at least one RS pattern;
RS resource block information indicating resource blocks that include at least one RS;
antenna port mapping information indicating a mapping of the RS in the at least one RS pattern and one or more antenna ports; or
enabling or disabling RS information indicating particular REs of the at least one RS pattern are enabled or disabled for transmission of the RS in the at least one RS pattern.

10. The apparatus of claim 9, wherein the RS resource block information comprises a bitmap, and wherein resource blocks that include the at least one RS are indicated in the bitmap by a first bit value, and resource blocks that do not include any RS are indicated by a second bit value.

11. A method comprising:
transmitting configuration information to be used in conjunction with at least one reference signal (RS) pattern to determine when transmission of an RS occurs in a resource zone comprising at least one subband, and each subband of the at least one subband comprises at least one resource block,
wherein the RS is determined to be transmitted or received based on the at least one RS pattern and the configuration information.

12. The method of claim 11, further comprising:
transmitting the at least one RS pattern, each of the at least one RS pattern indicating particular resource elements of a resource block used for the RS, wherein the resource block comprises a plurality of resource elements.

13. The method of claim 11, wherein the configuration information indicates at least one of:
a number of resource block (RB) groups in a subband of the at least one subband;
a number of RBs in each RB group;
a starting RB indicating a first end of a subband of the at least one subband;
an ending RB indicating a second end of a subband of the at least one subband;
a transmission bandwidth for the RS;
a reference point for a start of the RS; or
an indication to partition a wide band into a plurality of subbands.

14. The method of claim 11, wherein the configuration information comprises RS pattern modification information or RS pattern mapping information comprising at least one of:
pattern shift information indicating a shift of location of resource elements (REs) used for the RS in the at least one RS pattern;
RS pattern density change information indicating a change in a number of REs used for the RS within the at least one RS pattern;
RS resource block information indicating resource blocks that include at least one RS;
antenna port mapping information indicating a mapping of the RS in the at least one RS pattern and one or more antenna ports; or
enabling/disabling RS information indicating particular REs of the at least one RS pattern are enabled or disabled for transmission of the RS in the at least one RS pattern.

15. The method of claim 14, wherein the RS resource block information comprises a bitmap, and wherein resource blocks that include the at least one RS are indicated in the bitmap by a first bit value, and resource blocks that do not include any RS are indicated by a second bit value.

16. An apparatus comprising:
at least one processor; and
a computer-readable medium having stored thereon, computer executable instructions, that when executed cause the at least one processor to perform operations:
transmitting configuration information to be used in conjunction with at least one reference signal (RS) pattern to determine when transmission of an RS occurs in a resource zone comprising at least one subband, and each subband of the at least one subband comprises at least one resource block,
wherein the RS is determined to be transmitted or received based on the at least one RS pattern and the configuration information.

17. The apparatus of claim 16, the operations further comprising:
transmitting the at least one RS pattern, each of the at least one RS pattern indicating particular resource elements of a resource block used for the RS, wherein the resource block comprises a plurality of resource elements.

18. The apparatus of claim 16, wherein the configuration information indicates at least one of:
a number of resource block (RB) groups in a subband of the at least one subband;
a number of RBs in each RB group;
a starting RB indicating a first end of a subband of the at least one subband;
an ending RB indicating a second end of a subband of the at least one subband;
a transmission bandwidth for the RS;
a reference point for a start of the RS; or
an indication to partition a wide band into a plurality of subbands.

19. The apparatus of claim 16, wherein the configuration information comprises RS pattern modification information or RS pattern mapping information comprising at least one of:
pattern shift information indicating a shift of location of resource elements (REs) used for the RS in the at least one RS pattern;
RS pattern density change information indicating a change in a number of REs used for the RS within the at least one RS pattern;
RS resource block information indicating resource blocks that include at least one RS;
antenna port mapping information indicating a mapping of the RS in the at least one RS pattern and one or more antenna ports; or
enabling/disabling RS information indicating particular REs of the at least one RS pattern are enabled or disabled for transmission of the RS in the at least one RS pattern.

20. The apparatus of claim 19, wherein the RS resource block information comprises a bitmap, and wherein resource blocks that include the at least one RS are indicated in the bitmap by a first bit value, and resource blocks that do not include any RS are indicated by a second bit value.
